(19) United States
(12) Patent Application Publication
(10) Pub. No.: US 2012/0218104 A1
(43) Pub. Date: Aug. 30, 2012

(54) SIGNAL TRANSMITTING APPARATUS

(76) Inventor: Yu Cheng Lai, Taichung City (TW)

(21) Appl. No.: 13/037,314

(22) Filed: Feb. 28, 2011

(51) Int. Cl. G08B 21/00

(52) U.S. Cl. 340/540

(57) ABSTRACT

A signal transmitting apparatus in accordance with the present invention comprises two connecting wires. Two connectors are respectively to two opposite ends of each of the two connecting wires. Two alarm devices are mounted on the two connecting wires and each near a corresponding one of the two connectors. Two conducting wires are respectively connected to the two alarm devices to form a closed circuit such that the two alarm devices are synchronously operated when one of the two alarm devices is connected to a power source for user to confirm a connecting wire is operated in somewhere.

### BACKGROUND OF THE INVENTION

1. Field of the Invention

The present invention relates to a signal transmitting apparatus, and more particularly to a signal transmitting apparatus for operator to choice a correct one connecting wire when the signal transmitting apparatus is complex.

2. Description of Related Art

According to the FTTH (fiber to the home) works, the optical fiber is widely used because the optical fiber has a small volume, slight weight and can reliably transmit signals. However, it is very inconvenient for looking and checking a correct one of the optical fibers when the optical fiber is numerous, long and complex because the incoming/outgoing wavelengths of two connected ends of the optical fiber must be equal, that's, the two opposite ends must have two optical modules with same wavelength. The simplest way to differentiate between the complex optical fiber is to use the color of the cover of the optical fiber. However, it is difficult when the colors are similar to one another. Another way to differentiate optical fibers is to encode every optical fiber. For example, to differentiating optical fiber in control room, cabinet in row, cabinet in layer and router, the optical fiber can be encode as A1-3/4-04-48 that is wrote on a label adhered on the optical fiber.

However, the conventional ways for differentiating optical fibers has several disadvantages as follow.

1. The encode way is different due to different operators such that the newcomer can not understand the encode rule by the prior operator.

2. The label may be detached from the optical fiber or adhered to a wrong optical fiber.

3. The words on the label may be faded after being used for period of time.

4. The operator must previously memorize the code of the error optical fiber before looking and checking. It will take a lot of time. In addition, the right optical fiber shall be cut off the signal when the operator takes a wrong code.

The present invention has arisen to mitigate and/or obviate the disadvantages of the conventional method for differentiating optical fibers.

### SUMMARY OF THE INVENTION

The main objective of the present invention is to provide an improved signal transmitting apparatus for operator to choice a correct one connecting wire when the signal transmitting apparatus is complex.

To achieve the objective, the signal transmitting apparatus in accordance with the present invention comprises two connecting wires. Two connectors are respectively to two opposite ends of each of the two connecting wires. Two alarm devices are mounted on the two connecting wires and each near a corresponding one of the two connectors. Two conducting wires are respectively connected to the two alarm devices to form a closed circuit such that the two alarm devices are synchronously operated when one of the two alarm devices is connected to a power source for user to confirm a connecting wire is operated in somewhere.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional optical fiber jumper in accordance with the prior art;

FIG. 2 is a perspective view of a signal transmitting apparatus in accordance with the present invention;

FIG. 3 is a partially exploded perspective view of the signal transmitting apparatus in FIG. 2;

FIG. 4A is a cross-sectional view of a first embodiment of the signal transmitting apparatus in accordance with the present invention;

FIG. 4B is a cross-sectional view of a second embodiment of the signal transmitting apparatus in accordance with the present invention;

FIG. 4C is a cross-sectional view of a third embodiment of the signal transmitting apparatus in accordance with the present invention;

FIG. 4D is a cross-sectional view of a fourth embodiment of the signal transmitting apparatus in accordance with the present invention;

FIG. 5 is a cross-sectional view of a fifth embodiment of the signal transmitting apparatus in accordance with the present invention; and

FIG. 6 is a cross-sectional view of a sixth embodiment of the signal transmitting apparatus in accordance with the present invention.

### DETAILED DESCRIPTION OF THE INVENTION

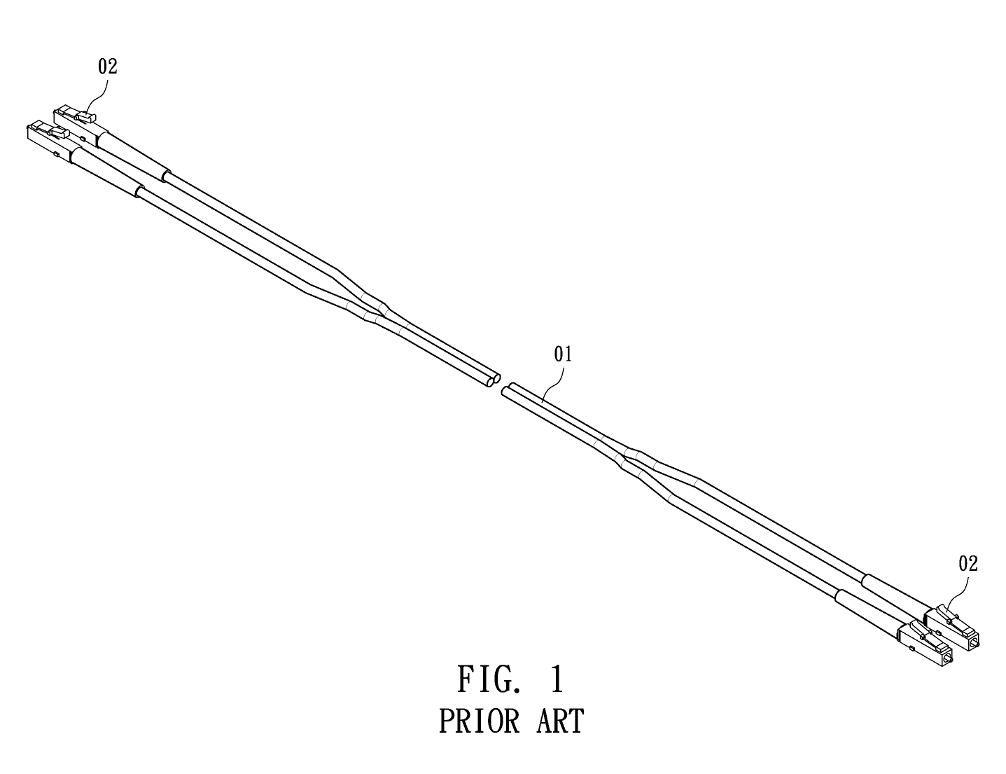

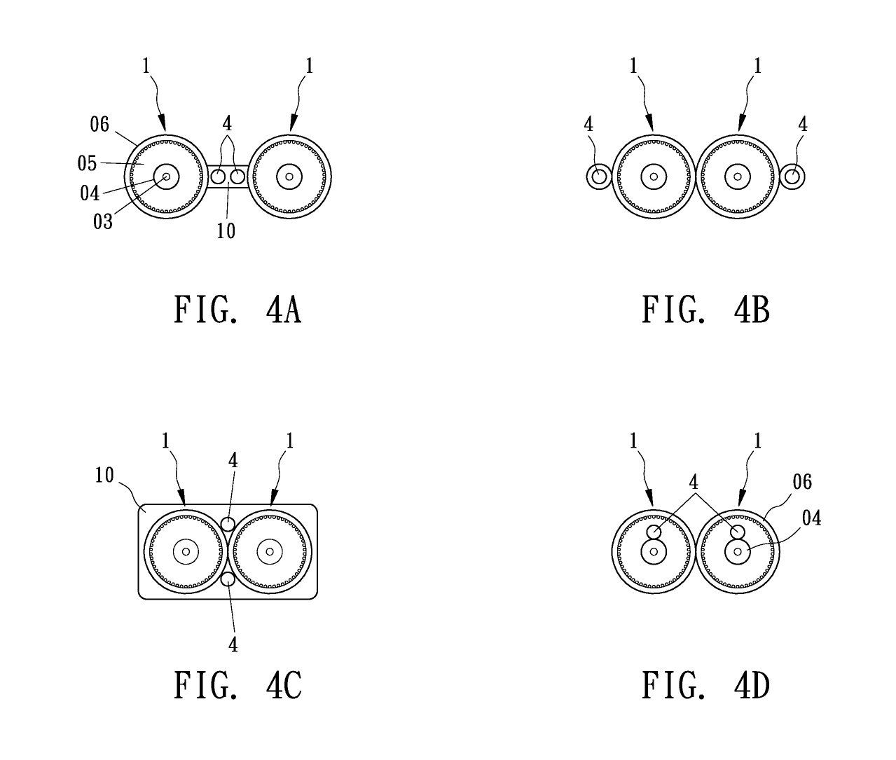

Referring to the drawings and initially to FIG. 1, a conventional duplex signal transmitting apparatus includes two ropes 01. Each rope 01 has two connectors 02 respectively connected to two opposite ends thereof. Further with reference to FIG. 4A, as usual, the rope 01 has a core 03 that is sequentially coated with an inner coating layer 04, an enhancing layer 05 and an outer coating layer 06. The two connectors 02 are respectively connected to two different equipments for transmitting signals. However, it is difficult to find and check a suitable rope 01 when the rope 01 is numerous, long and complex.

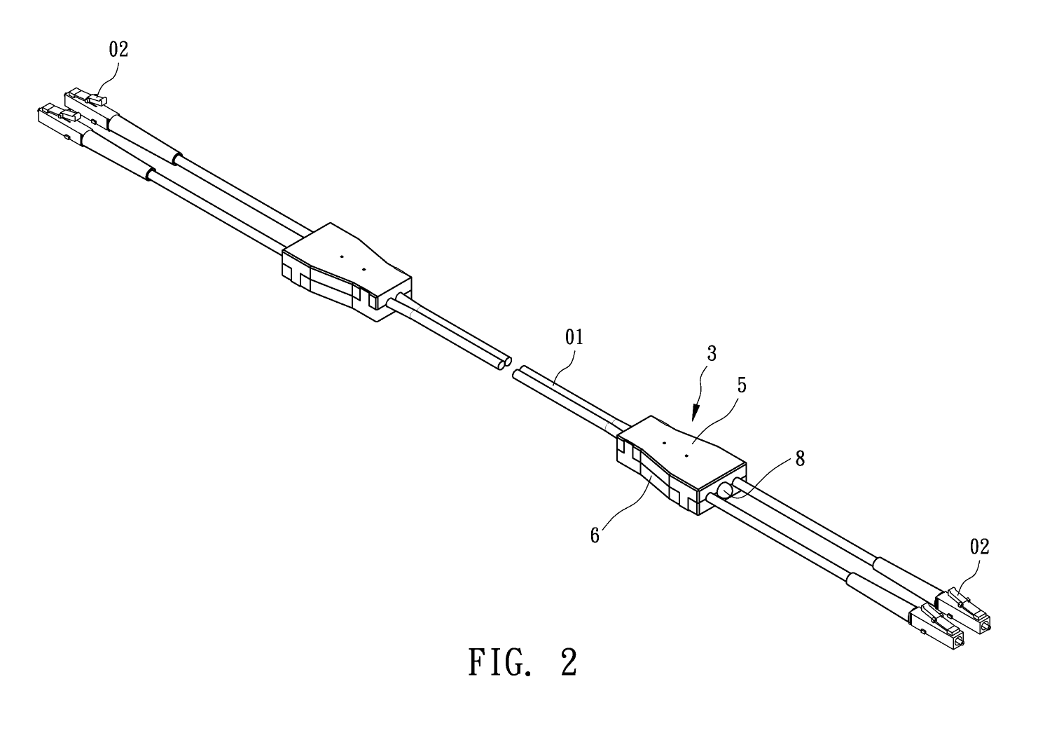

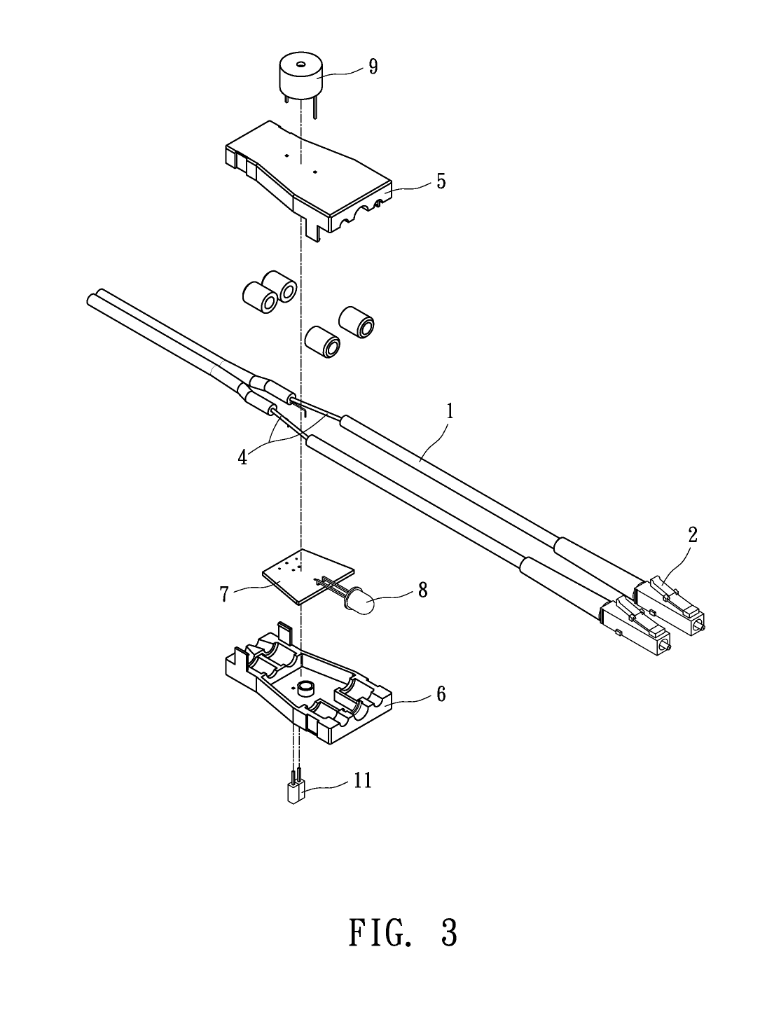

With reference to FIGS. 2 and 3, a signal transmitting apparatus in accordance with the present invention comprises two connecting wires 1. Two connectors 2 are respectively to two opposite ends of each of the two connecting wires 1. Two alarm devices 3 are mounted on the two connecting wires 1 and each near a corresponding one of the two connectors 2. Two conducting wires 4 are respectively connected to the two alarm devices 3 to form a closed circuit such that the two alarm devices 3 are synchronously operated when one of the two alarm devices 3 is connected to a power source for user to confirm a connecting wire 1 is operated in somewhere. In the preferred embodiment of the present invention, the alarm device 3 has a first housing 5 and a second housing 6 abutting each other to define a chamber (not numbered) for receiving a circuit board 7 that is electrically connected to the two conducting wires 4. At least one alarm element is peripherally mounted on the alarm device 3 and electrically connected to the circuit board 7. In the preferred embodiment of the present invention, the alarm element is an LED 8 or a buzzer 9. However, the LED 8 and the buzzer 9 can be mounted on the alarm device 3 together if necessary. A power plug 11 is selectively mounted onto the alarm device 3 and electrically connected to the circuit board 7 such that the two alarm devices 3 are operated when the power plug 11 mounted onto one of the two alarm devices 3.

Hereinafter, the preferred embodiment of the signal transmitting apparatus on accordance with the present invention is an optical fiber jumper such that the connecting wire 1 is an optical fiber. With reference to FIG. 4A, the optical fiber is duplex, wherein the two conducting wires 4 are respectively coated in insulating material 10 and disposed between the two connecting wires 1. The insulating material 10 is polyvinyl chloride (PVC). With reference to FIG. 4B, the two conducting wires 4 are respectively coated in insulating material 10 and respectively laterally connected to a corresponding one of the two connecting wires 1. With reference to FIG. 4C, the two conducting wires 4 and the two connecting wires 1 abut one another. The two conducting wires 4 and the two connecting wires 1 are coated in insulating material 10. With reference to FIG. 4D, each conducting wire 4 is disposed between the inner coating layer 04 and the outer coating layer 06 of a corresponding one of the two connecting wires 1. With reference to FIG. 6, multiple connecting wires 1, in FIG. 4D, can be roped to form a optical cable if necessary.

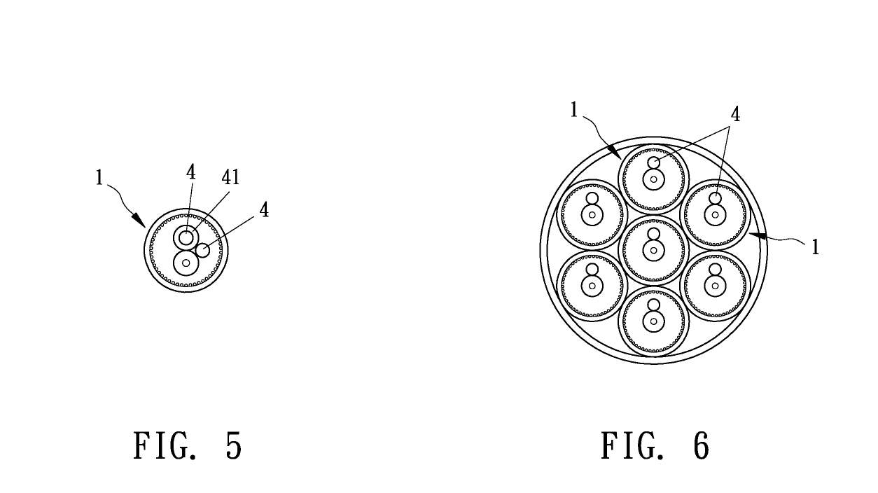

With reference to FIG. 5, the signal transmitting apparatus on the present invention is a simplex optical fiber jumper and the two conducting wires 4 are disposed between the inner coating layer 04 and the outer coating layer 06, wherein one conducting wire 4 is bared and the other is coated in an insulating layer 41.

As described above, the two alarm devices 3 are operated at the same time when the power plug 11 is mounted to one of the two alarm devices 3. Consequently, the operator can easily choice a suitable one connecting wire 3 when the connecting wire is numerous, long and complex.

Although the invention has been explained in relation to its preferred embodiment, it is to be understood that many other possible modifications and variations can be made without departing from the spirit and scope of the invention as hereinafter claimed.

What is claimed is:

1. A signal transmitting apparatus comprising at least one connecting wire, two connectors respectively to two opposite ends of the connecting wires, two alarm devices mounted on the at least one connecting wires and each near a corresponding one of the two connectors, two conducting wires respectively connected to the two alarm devices to form a closed circuit such that the two alarm devices are synchronously operated when one of the two alarm devices is connected to a power source for user to confirm a connecting wire 1 is operated in somewhere.

2. The signal transmitting apparatus as claimed in claim 1, wherein the alarm device includes a first housing and a second housing abutting each other to define a chamber for receiving a circuit board that is electrically connected to the two conducting wires, at least one alarm element peripherally mounted on the alarm device and electrically connected to the circuit board.

3. The signal transmitting apparatus as claimed in claim 2, wherein the alarm device includes an alarm element that is an LED.

4. The signal transmitting apparatus as claimed in claim 2, wherein the alarm device includes an alarm element that is a buzzer.

5. The signal transmitting apparatus as claimed in claim 2, wherein the alarm device includes two alarm elements that are LED and buzzer.

6. The signal transmitting apparatus as claimed in claim 1 comprising two connecting wires that are optical fibers, wherein each connecting wire includes a core that is sequentially coated with an inner coating layer and an outer coating layer, the two conducting wires respectively peripherally mounted to the outer coating layer of a corresponding one of the two connecting wires.

7. The signal transmitting apparatus as claimed in claim 1 comprising two connecting wires that are optical fibers, wherein each connecting wire includes a core that is sequentially coated with an inner coating layer and an outer coating layer, the two conducting wires respectively disposed between the inner coating layer and the outer coating layer of a corresponding one of the two connecting wires.

8. The signal transmitting apparatus as claimed in claim 1 comprising one connecting wire that is an optical fiber, wherein the connecting wire includes a core that is sequentially coated with an inner coating layer and an outer coating layer, the two conducting wires respectively disposed between the inner coating layer and the outer coating layer of the connecting wire.

9. The signal transmitting apparatus as claimed in claim 8, wherein one of the conducting is bared and the other is coated in an insulating layer.
